(19) United States
(12) Patent Application Publication
(10) Pub. No.: US 2009/0008959 A1
(43) Pub. Date: Jan. 8, 2009

(54) VEHICLE DOOR

(76) Inventor: Mikael Rehn, Stromstad (SE)

Correspondence Address: Dickinson Wright PLLC, 38525 Woodward Avenue, Suite 2000, Bloomfield Hills, MI, 48304, US

(21) Appl. No.: 12/142,125

(22) Filed: Jun. 19, 2008

(30) Foreign Application Priority Data
Jun. 21, 2007 (EP) EP07110751

(51) Int. Cl. B60J 5/00; B60J 5/04; A44B 21/00

(52) U.S. Cl. 296/146.7; 24/593.1

(57) ABSTRACT

The invention relates to a vehicle door including a door shell with an outer panel (2) secured to an inner panel (3), with the inner panel having an opening therein, and with the door shell defining a hollow cavity. An interior trim module (4) is arranged to be fastened to the inner panel (3), by means of at least two fasteners (5, 9). Each fastener (5, 9) includes a first portion (5; 9) attached to the inner panel and a second portion (9; 5) attached to the interior trim module (4), or vice versa, with the first and second portions at least partially form-fitting male and female portions, respectively, extending from a flat base, so that the first and second portions are arranged for cooperation in a plane parallel to contacting surfaces of the inner panel and the interior trim module.

### CROSS REFERENCE TO RELATED APPLICATIONS

The present application claims priority to European Patent Application 07110751 entitled VEHICLE DOOR, filed on Jun. 21, 2007.

### BACKGROUND OF THE INVENTION

1. Field of the Invention

The present invention relates to a vehicle door wherein an interior trim module is arranged to be fastened to an inner panel by means of at least two fasteners.

2. Related Art

Manufacturers of motor vehicles have long been faced with the difficult task of constructing a door which not only provides easy ingress and egress but also performs a variety of other functions such as mounting a window, a window regulator mechanism and other auxiliary devices. Conventional, vehicle doors include an inner panel and an outer panel fixed together about their edges to form a hollow sheet metal or moulded plastic shell in at least the interior lower portion thereof. The inner panel typically includes a number of access apertures for permitting the insertion of auxiliary devices such as the window regulator mechanism and a door actuation device. However, the insertion and subsequent attachment of the door auxiliary devices tends to be a time consuming process that is inconvenient for the vehicle door assembler and costly to the vehicle manufacturer.

Previous attempts to reduce the time required for door assembly have failed to produce satisfactory results particularly with regard to the appearance and structure of the door. In one example, an inner panel sub-assembly is produced off-line and then attached during one of the final steps of vehicle assembly. However, some portions of the inner panel sub-assembly are exposed to an occupant's view after assembly. Unfortunately, difficulty often arises when attempting to match the color of the components painted on-line with the color of the components painted off-line. A common solution is to use a separate interior trim member for mounting auxiliary devices such as the window regulator and the window glass. This design requires that a door trim member comprising the said auxiliary devices and covering a major part of the inner door panel are brought together and assembled at a fairly late stage of the assembly process.

US 2004/135394 relates to a vehicular door trim member for attachment to an inner door panel of a vehicle. The vehicular door trim member is defined by a rigid sheet provided with one or more resilient clip fasteners. The resilient clip fasteners and the rigid sheet comprise an integral one-piece moulded construction. The vehicular door trim member is attached to the door by inserting the resilient clip fasteners into apertures formed within the inner door.

One problem with this solution is that the mounting of the interior trim is cumbersome, as each resilient clip fastener must be aligned with the said apertures prior to the insertion and securing operation. An incorrectly mounted resilient clip fastener may also cause the interior trim to move relative to the interior trim after assembly, so that a rattling noise may be generated during use of the vehicle. Subsequent removal of the interior trim to allow servicing, replacement or mounting of additional auxiliary devices, such as motors for power windows or loudspeakers, may cause resilient clip fasteners to deform or break. This requires an additional step of replacing one or more resilient clip fasteners.

Some of the above problems have been solved by the arrangement shown in DE 37 40 988. This document discloses a door comprising a door shell coupled to a door module. The door shell includes an outer panel secured to an inner panel, the inner panel having an opening therein. The door shell defines a hollow cavity. The door module includes a cassette and an interior trim panel coupled to the cassette. The door module further includes an attachment means for securing the door module to the door shell. The attachment means comprises a number of hooks arranged for cooperation with a corresponding number of cut-outs in the inner panel.

This arrangement solves the problem related to the subsequent removal of the interior trim. However, the problem relating to alignment of the fasteners with their respective apertures prior to the insertion and securing operation remains. Also, in order to allow the hook members to be inserted into said recesses, the width of the recesses is relatively large compared to the width of the hook members. This can cause the interior trim to move relative to the inner panel after assembly, whereby the problem relating to the generation of a rattling noise has not been solved. In addition, the hook members are in direct contact with a relatively sharp upper edge when mounted in a cavity, which may cause damage to the hook members over time.

The invention relates to an improved interior trim assembly for a vehicle and a fastener means for use in such an assembly. The interior trim assembly according to the invention is intended to solve the above problems relating to the assembly of interior trim to an inner panel, as well as the problem relating to relative movement between the interior trim and the inner panel, as stated above.

### SUMMARY OF THE INVENTION

The above problems have been solved by a method and an arrangement according to the appended claims.

According to one aspect of the present invention a vehicle door includes a door shell with an outer panel secured to an inner panel. The inner panel may have an opening therein, and the door shell may define a hollow cavity. An interior trim module is arranged to be fastened to the inner panel by means of at least two fasteners. The vehicle door may be a front or rear side door or a rear door for a station wagon or delivery type vehicle.

Each fastener may include a first portion attached to the inner panel and a second portion attached to the interior trim module, or vice versa, wherein the first and second portions are configured as at least partially form-fitting male and female portions, respectively. In this context, the term “form-fitting” defines two interacting and positioning members arranged to be positive locking, or form closed (cf. the German term “Formschlüssig”), when said portions reach their assembled position. This can be achieved by providing the respective members with a pair of facing and a pair of opposing control surfaces having substantially the same dimensions in at least two orthogonal directions, such as the horizontal X- and Y-directions. A further control surface, one on each portion, may be provided to define a final, assembled position in the third orthogonal direction, such as the vertical Z-direction. The form fitting male and female portions will provide an improved relative positioning of the respective inner panel and interior module during and after assembly. In addition, the form fitting feature will provide the assembled male and female portions with support in the X-, Y- and Z-directions between said portions, in order to prevent relative movement between the respective inner panel and interior module.

The male and female portions may each be arranged integral with and extending from a flat base, wherein a respective male and female base is attached to the inner panel and interior trim module. The first and second portions may be arranged for cooperation in a plane parallel to contacting surfaces of the inner panel and the interior trim module. This plane coincides with the main surface of the vehicle door and may be a substantially vertical plane. The respective male base and female base may be attached to the inner panel and interior trim module by a resilient snap in arrangement on the rear side of each base. The male and female portions may then be snapped into place in cut-outs corresponding to the shape of said resilient snap in arrangement. The cut-outs are located in the respective panel and interior module and cooperate with the male and female portions to maintain each portion in a fixed position. However, the bases can also be attached by means of an adhesive, or any other suitable fixing means. In this way, the male and female portions may be easily assembled and disassembled, while each portion is fixed to the respective panel and interior module. In order to avoid so called “rattle and squeak”, it is preferable that the male and female portions are not movable relative to the respective panel and interior module.

A leading portion of at least one of the male and the female portions may comprise a guide surface, arranged to facilitate alignment and control of relative movement between the cooperating male and female portions during an initial period of the assembly sequence.

The male and female portions are preferably, but not necessarily, arranged to cooperate in a vertical plane. In this way, the inner panel and interior trim module are located displaced relative to each other in the vertical direction, with the male portions on the interior trim module located above and aligned with the female portions on the inner panel. Alternatively, the female portions on the interior trim module located above and aligned with the male portions on the inner panel. The interior trim module may then be lowered into position until the male and female portions reach their form-fitting position. According to a further alternative, the male and female portions may be arranged to cooperate in a horizontal plane.

The male portion may comprise a shaped profile comprising a leg extending, preferably, but not necessarily, at right angles from the integral base and an enlarged profile having a predetermined cross-sectional shape is provided at the end of said leg. The female portion comprises a cavity formed by walls extending outwards from the base, which cavity is open at one end and closed at the opposite end. The cavity is provided with a slot located in a surface facing the male portion and its base, which slot extends from the said open end and is arranged to receive the leg of said shaped profile. According to one non-limiting example, the male portion may have a T-shaped profile. In this case, the width of the cross-bar of the T-shape profile equals the internal width of the cavity in the female portion along at least half the length of the male portion, when the male and female portions are in their assembled position.

The width of the cross-bar, and that of the corresponding cooperating section of the cavity, may vary along the longitudinal extension of the T-shaped profile. For instance, the width of the profile may increase from the leading end of the male portion and the width of the female portion may increase towards the open end of the cavity. In this way, the leading end of the male portion and the open end of the female portion may act as cooperating guide surfaces.

In their assembled position, opposing contact surfaces of the male and female portions may be arranged to extend along at least half the length of the male portion. According to one example, the opposing contact surfaces may be located along the underside of the T-shaped cross-bar, on either side of and along the leg, and on the inner surface of the cavity, on either side of the slot. In this way the cooperating form-closed male and female portions may guide the interior trim module into position relative to the inner panel during assembly, and locate and maintain said components in position after assembly. In their assembled position, the male portion and the female portion are preferably, but not necessarily, arranged to be form fitting along at least half the length of the male portion.

According to another aspect of the present invention, the opposing contact surfaces on the male and the female portions may be provided with cooperating surfaces forming a snap-in arrangement. Such a snap-in arrangement may include a single projection or a rib located transverse to the direction of mounting, and a cooperating notch or a transverse groove. The snap-in arrangement is operable as an audible indication of correct mounting position.

The male and female portions may be made from any suitable plastic material, such as polypropylene (PP), and may be manufactured for instance by injection moulding.

In order to maintain the interior trim module and the inner panel in position after assembly, at least one removable fastener is arranged to connect the interior trim module and the inner panel and to prevent movement between the male and female portions. For example, such a removable fastener may comprise a screw or clip that is inserted and fastened in an aperture extending through overlapping portions of the interior trim module and the inner panel, when in their assembled position. According to one example, the removable fastener may be mounted at right angles to the direction of assembly of the interior trim module. The removable fastener may preferably be located in a position where it is not visible when the vehicle door is located in its closed position on a vehicle.

### BRIEF DESCRIPTION OF DRAWINGS

The invention will be described in detail with reference to the attached figures. It is to be understood that the drawings are designed solely for the purpose of illustration and are not intended as a definition of the limits of the invention, for which reference should be made to the appended claims. It should be further understood that the drawings are not necessarily drawn to scale and that, unless otherwise indicated, they are merely intended to schematically illustrate the structures and procedures described herein.

FIG. 1 is a schematic exploded view of a door arrangement with a according to one embodiment of the present invention.

FIG. 2 is a side view of an interior trim module provided with male portions of a fastener according to the present invention,

FIG. 3 illustrates an example of male and female portions making up a fastener according to the present invention.

### DETAILED DESCRIPTION OF THE PREFERRED EMBODIMENTS

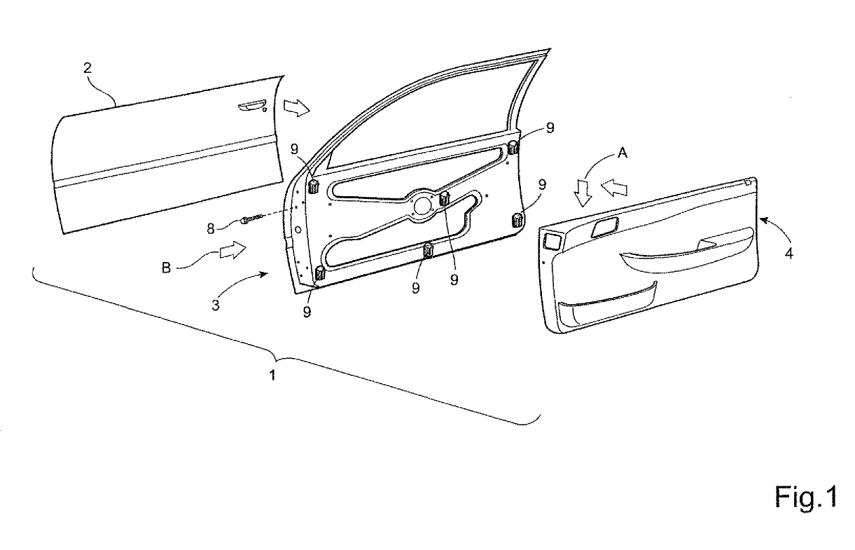

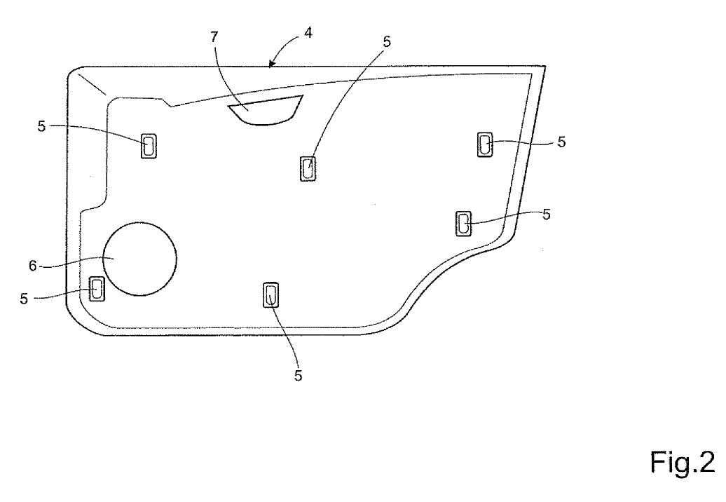

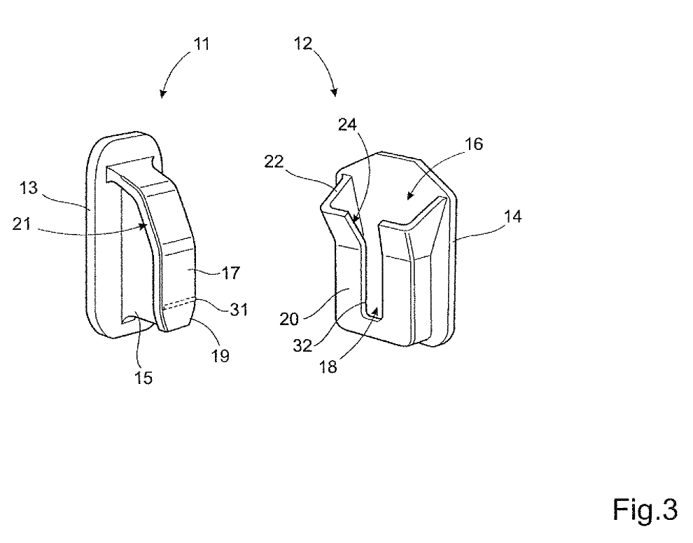

FIG. 1 shows a door arrangement according to one embodiment of the invention. The door arrangement 1 includes a door shell 2, 3 with an outer panel 2 secured to an inner panel 3. Inner panel 2 is provided with openings therein. The door shell defines a hollow cavity arranged for receiving auxiliary components (not shown), such as a window, window operating motors, loudspeakers and a door lock. Outer panel 2 is secured to the inner panel 3 by means of welding, soldering or by an adhesive, depending on the choice of materials in the respective panels. An interior trim module, 4 is arranged to be fastened to inner panel 3 by means of a number of fastener means (not shown) comprising cooperating male and female portions which will be described in connection with FIG. 3 below. For this purpose, inner panel 3 is provided with, in this case, six female portions, 9, of a fastener means according to the invention. These female portions 9 are arranged to cooperate with corresponding male portions, 5, shown in FIG. 2.

FIG. 2 is a side view of the interior trim module 4 of FIG. 1, which interior trim module 4 is provided with, in this example, six male portions 5 of the fastener system according to the invention. The locations of male portions 5 of the fastener system are dependent on the position and weight of any auxiliary components, such as a loudspeaker 6, attached to the interior trim module 4, and/or on the location of components subjected to external loads, such as a door opening handle 7. Consequently, a smaller and relatively light interior trim module for a sports car may use two-three fasteners, while a luxury car may require five or more fasteners depending on the number of auxiliary components.

In order to maintain the interior trim module and the inner panel in position after assembly, at least one removable fastener is arranged to connect the interior trim module and the inner panel and to prevent movement between the male and female portions. In this example, the removable fastener, 8, is configured as a screw that is inserted and fastened in an aperture extending through overlapping portions of interior trim module 4 and inner panel 3, when in their assembled position. In the example shown, removable fastener 8 is mounted at right angles to the direction of assembly of the interior trim module 4. In FIG. 1 the direction of assembly of the interior trim onto the inner panel 3 is indicated by the arrow A and the direction of mounting the removable fastener 8 is indicated by the arrow B. During assembly, interior trim 4 is first moved towards the inner panel 3, so that the male portions 5 of the fastener means are aligned over the female portions 9. Interior trim 4 is then moved downwards, in the direction of the arrow A, bringing the male and female portions 5 and 9 into form fitting contact with each other. Finally, the interior trim 4 and the inner panel are locked in position by the removable fastener 8, which is inserted through a first opening in the forward end surface of the interior trim and into a corresponding second opening in the inner panel 3, where it is screwed into place to lock the assembled parts together. The removable fastener is preferably located in a position where it is not visible when the vehicle door is located in its closed position on a vehicle.

FIG. 3 shows an example of a male and a female portion 11, 12 making up a fastener system according to the invention. Each fastener includes a first portion attached to the inner panel and a second portion attached to the interior trim module, or vice versa, with the first and second portions including at least partially form-fitting male and female portions, respectively. The term “form-fitting” has been defined above. In the particular embodiment of FIG. 1 and FIG. 2, male portion 11 is intended for attachment to the interior trim module 4 and the female portion 12 is intended for attachment to the inner panel 3.

The male and female portions 11, 12 are each arranged integral with and extending from a flat base 13, 14, respectively. The respective male base 13 and female base 14 can be attached to suitable cut-outs in the inner panel 3 and interior trim module 4 by a resilient snap in arrangement (not shown) on the rear side of each base. However, the bases 13, 14 can also be attached by means of an adhesive, or any other suitable fixing device.

Male portion 11 is configured as a shaped profile with a leg, 15, extending at right angles from integral base 13, and an enlarged profile, 17, having a predetermined cross-sectional shape is provided at the end of leg 15. According to this example, male portion 11 has a T-shaped profile, with the enlarged profile having cross-bar 17. Female portion 12 is configured as a cavity, 16, formed by walls extending outwards from base 14, with cavity 16 being open at an upper end 22 and closed at the opposite, lower end. Cavity 16 is provided with a slot, 18, located in a surface facing, 20, the male portion and its base, 13, which slot 18 extends from the said open end 22 and is arranged to receive the leg 15 of said shaped profile. In this case, the width of the cross-bar 17 of the T-shaped profile equals the internal width of cavity 16 in female portion 12 along substantially half the length of cross-bar 17, when the male and female portions 11, 12 are in their assembled, form-fitting position.

The width of cross-bar 17, and that of the corresponding cooperating section of cavity 16, varies along the longitudinal extension of T-shaped profile cross bar 17. In this example, the width of cross bar 17 increases from a tapering section of leading end 19 of male portion 11. Similarly, the width of female portion 12 increases towards the open end 22 of cavity 16. In this way, leading end 19 of male portion 11 and open end 22 of female portion 12 can act as cooperating guide surfaces during an initial period of the assembly sequence.

The height of leg 15 is constant from the leading edge of the T-shaped profile for a predetermined distance along its length. Along this section of cross-bar 17 the outer surface of the T-shaped profile on male portion 11 will contact the outer surface of base 14 of female portion 12 when assembled. The height of the leg will then decrease gradually, until cross-bar 17 joins base 13. This arrangement provides added stability for the T-shaped profile, as well as additional contact surfaces between the male and female portions 11, 12. In their assembled position, the additional, opposing contact surfaces of male and female portions 11, 12 are arranged to extend along at least half the length of male portion 11 and substantially along the entire length of slot 18. According to the example shown, the opposing contact surfaces may be located along the underside of T-shaped cross-bar 17, on either side of and along the leg 15, and on an outwardly angled, upper guide surface 24 of cavity 16, on either side of slot 18.

In this way the cooperating form-closed male and female portions 11, 12 can guide the interior trim module 4 into position relative to the inner panel 3 during assembly, and locate and maintain these components in position after assembly. In their assembled position, the male portion and the female portion are preferably, but not necessarily, arranged to be form fitting along at least half the length of the male portion.

According to a further example, the opposing contact surfaces on the male and the female portions 11, 12 are provided with cooperating surfaces forming a snap-in arrangement. As indicated with dotted lines in FIG. 3, such a snap-in arrangement may comprise a single rib, 31, located transverse to the direction of mounting, and a cooperating transverse groove, 32. The snap-in arrangement is operable as an audible indication of the male and female portions 11, 12 reaching the correct mounting position.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

1. A vehicle door comprising a door shell including an outer panel secured to an inner panel, said inner panel having an opening therein, with said door shell defining a hollow cavity; an interior trim module arranged to be fastened to the inner panel, and a plurality of fasteners; with at least one of said fasteners comprising a first portion attached to the inner panel and a second portion attached to the interior trim module, wherein said first and second portions comprise at least partially form-fitting male and female portions, respectively, extending from a flat base, and that the first and second portions are arranged for cooperation in a plane parallel to contacting surfaces of the inner panel and the interior trim module.

2. A vehicle door according to claim 1, wherein a leading portion of at least one of the male and the female portions comprises a guide surface.

3. A vehicle door according to claim 1, wherein the male and female portions of said at least one fastener are arranged to cooperate in a vertical plane.

4. A vehicle door according to claim 1 wherein the male and female portions of said at least one fastener are arranged to cooperate in a horizontal plane.

5. A vehicle door according to claims 1, wherein the male portion of said at least one fastener comprises a shaped profile comprising a leg extending at right angles from the base with an enlarged profile at the end of said leg.

6. A vehicle door according to claim 5, wherein the male portion has a T-shaped profile.

7. A vehicle door according to claim 6, wherein the width of a cross bar in the T-shape profile equals the internal width of the female cavity along at least half the length of the male portion.

8. A vehicle door according to claim 5, wherein the female portion of said at least one fastener comprises a cavity with a slot in a surface facing the male portion, which slot is arranged to receive the leg of said shaped profile.

9. A vehicle door according to claim 8, wherein the width of the profile increases from the leading end of the male portion and the width of the female portion increases towards the open end of the cavity.

10. A vehicle door according to claim 1, wherein, in their assembled position, opposing contact surfaces of the male and female portions are arranged to extend along at least half the length of the male portion.

11. A vehicle door according to claim 1, wherein in their assembled position, the male portion and the female portion are arranged to be form fitting along at least half the length of the male portion.

12. A vehicle door according to claim 1, wherein opposing surfaces on the male and the female portions are provided with cooperating surfaces forming a snap-in arrangement.

13. A vehicle door according to claim 12, wherein said snap-in arrangement is operable as an audible indication of correct mounting position.

14. A vehicle door according to claim 1, wherein at least one removable fastener is arranged to connect the interior trim module and the inner panel and to prevent movement between the male and female portions.
